(19) United States
(12) Patent Application Publication
(10) Pub. No.: US 2007/0220068 A1
(43) Pub. Date: Sep. 20, 2007

(54) ELECTRONIC DOCUMENT AND BUSINESS PROCESS CONTROL

(76) Inventors: Bruce Thompson, Golden, CO (US); Matthew Dewey, Broomfield, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/675,237

(22) Filed: Feb. 15, 2007

Related U.S. Application Data
(60) Provisional application No. 60/773,452, filed on Feb. 15, 2006.

(51) Int. Cl. G06F 17/30

(52) U.S. Cl. 707/203

(57) ABSTRACT

An electronic file control system is presented that generates a mirror copy of all controlled or “original” files. The system then allows controlled access to the original files. However, changes to the original files are not reflected in the mirror copies until authorized by an approving entity. That is, while users may access and change the original files, the utility may revert to the mirror copy of the file if the user does not have the authority to make the changes. That is, after the unauthorized user alters (e.g., edits, deletes, etc.) a file, the utility may replace the unauthorized edited file with the last authorized version of the file (i.e the mirror copy). Alternatively, when such changes are approved, the mirror copy may be updated and thereby become the latest authorized version of the file. Such controlled access to and replacement of files allows for controlling numerous business processes.

### CROSS-REFERENCE TO RELATED APPLICATIONS

This application claims priority under 35 U.S.C. 119 to U.S. Provisional Application No. 60/773,452, entitled, “SYSTEMS AND METHODS FOR CONTROLLING ELECTRONIC FILES,” filed on Feb. 15, 2006, the contents of which are incorporated herein as if set forth in full.

### BACKGROUND

Generally, version control developed from formalized processes based on tracking revisions of certain documents, such as blueprints. Implicit in this control was the ability to return to any earlier state of the design. For example, when a final engineering design had been achieved, earlier revisions of the design documentation were maintained such that engineers could “fall back” on those earlier revisions in case the final engineering design was flawed. Likewise, in computer software engineering, version control is involves tracking and providing control over changes to source code. Software developers may also use version control software to maintain documentation and configuration files associated with the source code.

At the simplest level of version control, developers have relied on retaining multiple copies of the different versions of the program and numbered them appropriately. For example, a version of software may be called version 1.0 where is a second increment to the version may be called version 1.1. A larger more substantial change would justify an increase in the software to version 2.0. This approach has been used on many large software projects and, while it is moderately effective, it is inefficient because many near-identical copies of the program have to be maintained. Accordingly, this approach often leads to human error. For example, an engineer may install the wrong copy of software with a system or even incorrectly edit finalized baseline version of the software such that new software bugs are introduced to the software.

Additionally, multiple versions of the same software are commonly deployed to different sites with software developers simultaneously updating those separate versions. Because each installation of a particular software may involve a unique system, it is often necessary to implement different versions of the software. Version control, in this regard, provides a baseline version of the software such that the changed versions may be compared to the baseline version for bug tracking. That is, the different software versions are singularly controlled to reduce the number of software bugs and other issues that are often created in different versions.

While version control software has made significant inroads into software development, its progress into other fields has been substantially limited due, at least in part, to its reliance upon database technology. For example, version control software generally interacts with a database to control access to the various electronic files contained therein. The version control software, being a separate and distinct software from the database software, often employs a complex user interface that limits the user's ability to manipulate those electronic files. Because of such complexity, version control software is generally been relegated to engineering endeavors and similar fields such as computer-aided drafting (CAD). In addition, such complexity has typically limited prior version control software to controlling changes in document versions. That is, such software is typically not operative to facilitate or control other processes that may be performed with electronic files.

### SUMMARY

Provided herein are systems and methods (i.e., utilities) that allow for controlling access to electronic files to allow for, inter alia, automated version control of electronic documents as well as control of other business processes. Such control may be exerted when, for example, a file is created, revised, approved, released, published, archived, made obsolete, etc. Generally, any time a file transitions from one state to another, the utility may perform one or more operations upon the occurrence of such transition. That is, an event sequence may be implemented upon the transition of a file from a first state to a second state. Such an event sequence may include a number of steps and may trigger additional sequences.

In one arrangement, the utilities may be incorporated into existing file system interfaces such that users need not utilize a specialized graphical user interface (i.e., GUI). For instance, the utility may be incorporated into a file navigation tool of an electrical file system. For instance, one common file navigation tool in which the utilities may be incorporated is Microsoft Windows Explorer®. Such file navigation tools typically allow a user to view different files contained within directories and subdirectories of a file system. Further, such navigation tools typically allow a user to access files within these directories. In this regard, a user need not open the appropriate program to access a particular file. Rather, the navigation tool launches the appropriate program when a file is selected. Accordingly, by integrating the utility into the navigation tool, document control may be provided for any type of files stored by the file system. That is, as the utilities are not application specific but rather work through the navigation tool, all file types may be supported. For instance, .doc files as well as, without limitation, .cad, .jpeg, .bmp, .html, etc., may be controlled. That is, the utility may be operative to identify transition states for any file types contained within a file directory and implement controls on the access, revision, replacement, deletion, etc. of those files, as will be discussed herein.

Typically, the utilities generate a mirror copy of all controlled or “original” files. The utilities then applies/controls the to the original files. While users may access and change the original files, the utility may revert to the mirror copy of the file if the user does not have the authority (e.g., as determined from log in information or other identification information) to make the changes. That is, after the unauthorized user alters (e.g., edits, deletes, etc.) a file, the utility may replace the unauthorized edited file with the last authorized version of the file (i.e the mirror copy). Alternatively, when a user with authority to change a file edits a file and/or such changes are approved, the mirror copy may be updated. In this regard, the mirror copy becomes the latest authorized version of the file. Such controlled access to and replacement of files allows for controlling numerous business processes. Further, such a utility may allow for access to all files in a file system such that users/employees may review the documents without having the ability to alter the mirror copy.

As noted, the utility is a software system that is integrated into the file navigation tool. In one arrangement, the software overlays existing file structure. In this regard, the utility may be substantially invisible to the user. That is, the view of the file system provided by the navigation tool may be substantially the same after integration of the utility as before. Accordingly, users may proceed as they did prior to integration of the utility, however, the utility may provide the control functions as presented herein. As the utility overlays the file navigation tool, the software has a failsafe feature built in. That is, should the utility fail or otherwise be shut down for any reason, the files will still be available to all users in the navigation tool, as well as the file system protections placed on the files. Only the automation provided by the system will not be available.

In one aspect, an electronic file control (EFC) software system is integrated with a file navigation tool of an electronic file system. In this regard, the EFC software system may control access to files within the electronic file system via the navigation tool. In this regard, the system may monitor the files for transitions between states (e.g., editing, deletion, etc.). For instance, when a user accesses or attempts to access a controlled file within the file system, an event sequence may be implemented. For instance, upon identifying access to a controlled file in the electronic file system, the system may determine if the accessing entity has authority to access the file. If authorized, the user may revise or otherwise utilize the file.

Subsequently, the user may, after revising the copy file, request that the file be returned to the file system (e.g., saved over the original version). This may trigger another event sequence for the EFC system. For instance, the EFC system may be configured to seek approval for the changes to the file. In this regard, the system may provide a notification to one or more predetermined authorizing/approving entities. Such a notification may include an electronic notification (e.g., an email notification) that lets the approver(s) know that revisions have been proposed for a controlled file within the controlled file system. In one arrangement, such a notification may provide direct access to the revised file. For instance, the notification may include a link to and/or a copy of the revised file for review. It will be further appreciated that a plurality of approvers may be notified. Further, each approver may be required to approve the changes and/or one of the approvers may have final authority. In any case, upon approval, the revised file may replace the mirror file within the electronic file system. In this regard, a new version of the controlled file may be generated within the electronic file system, and a mirror copy may be updated.

In a further arrangement, notifications of the new version of the controlled file may be sent to one or more users of the electronic file system. Such users may be prompted to review the revised file. In one arrangement, the system is operative to log access of the users to identify which users have reviewed the revised file. Further, the system may be configured to send reminder notifications to users who have not reviewed the revised file and/or notify third parties of the failure of one or more users to review the file.

In a further arrangement, the utility may be operative to archive a controlled file when that controlled file is replaced by a new version. Further, the utility may be operative to update one or more metadata entries for the archive control file, the revised file, etc. and/or the new version of the controlled file.

In a further arrangement, the utility allows for control of a file where the files may be simultaneously accessed by multiple users. In this regard, multiple users may be able to, for example, revise or work on a file simultaneously. In instances where a user who changes a file is not authorized to do so, or, where changes are not approved, the system may disregard the changes. That is, the edited file may be replaced by the mirror copy, which represents the last authorized version of the file.

The ability to generate mirror copies for use prior to approval provides a number of benefits. For instance, all files may be maintained in a central file system such that no one without predetermined approval may remove a particular file from the system nor can, for example, a disgruntled employee delete a critical file. Further, an administrator may now expose data/files to a larger number of people without fear that the data/files will become corrupted. That is, if data/files become corrupted, the system may utilize the mirror copy to restore the corrupted data/files to its original conditions.

In addition, the file control software allows for logging access to and from the files. Accordingly, an audit trail may be generated to log changes to any of the files. Accordingly, when a user accesses a file, the system may initially determine if the user is authorized to access that file and/or what level of access the user may have. For instance, a requesting user may be authorized to edit the requested file and its mirror copy or be authorized to propose changes to the file (i.e., edit the file and request approval for changes). The identity of assessing users, the time of access and/or the reason for access (e.g., entered by the user) may also be logged.

The software system may also implement metadata database for the various files within the file system. This may allow for generating alternative views of the controlled files based on specified metadata. In this regard, each file may have numerous different metadata entries. Likewise, the files may be sorted by such metadata entries.

In one arrangement, the providing and receiving steps may be performed in a client server architecture and/or formed in a peer-to-peer network structure.

Additional features made possible by the software system include storage options and retention periods based on data/file relevance. In this regard, documents or files may be deleted as they age in order to reduce data storage and backup costs and/or, for example, potential legal exposure beyond that which is legally mandated relative to data retention. Likewise, archiving may be performed on various different classes of data/files. For instance, different revision copies of the files may be archived to different locations. In this regard, the most current version of any data/file (e.g., mirror copies) may be archived in readily accessible storage locations whereas older versions may be archived using different storage methods (e.g., inexpensive tape backup).

According to another aspect, a software system is provided that is configurable with a client server architecture for providing business control relating to electronic documents. Such a system may include a document control module that is configured to track an electronic document associated with a business process. The software system may generate a mirror copy of controlled documents. In this regard, documents within the system may be accessible for editing, etc., but changes to the mirror copies of these files may be controlled. Such an electronic document may be accessible by a client within the client server network. The document control module may detect an event associated with the electronic document and generate a message that includes information relating to the event. The document control module includes a rule-processing engine that receives at least one externally input pertaining to the business process to generate an operation that controls the document according to the business process. The software system further includes an interface module that is communicatively coupled to the document control module and which receives messages from the document control module and formats the data of the messages for access by an end user.

As noted, the software system is configurable within a client server architecture. In this regard, the software system is operative to communicate with clients via the interface module in any appropriate manner. In one arrangement, the interface further includes a peer to peer module for interfacing the software system with the internet. In such an arrangement, clients may utilize browsers to access electronic documents associated with the business process.

### BRIEF DESCRIPTION OF THE DRAWINGS

FIG. 1 illustrates a files system in which a file control system is integrated.

FIG. 2 illustrates a request for revision text box.

FIGS. 3A and 3B illustrate approval and disapproval text boxes.

FIG. 4 illustrates a file's meta data.

FIG. 5 illustrates a spreadsheet showing metadata for each file in a file system.

FIG. 6 illustrates a pivot directory where files are sorted by metadata properties.

FIG. 7 illustrates an architecture for implementing the file control system in a client-server network.

FIG. 8 illustrates a rules engine for implementing rules of the file control system.

FIG. 9 illustrates implementing the system over the internet.

FIG. 10 is a process flow sheet illustrating the control of a business process.

### DETAILED DESCRIPTION OF THE DRAWINGS

In many organizations, almost every member/employee (hereafter employee) has access to a personal computer. Such employees generate ever-growing amounts of unstructured data (files, documents, etc.), from a variety of different applications in support of a wide spectrum of business processes. It is estimated that 40 to 50% of the data stored by today's businesses is unstructured data. Further, the access to and control of these files is often open to all employees. In this regard, anyone can put anything anywhere, call it anything they want, re-label or remove anything at anytime, without supervision. As a result, employees cannot readily find the information needed and when they do find it, they are not always sure it is the correct information/version. This negatively impacts employee productivity, business process quality, operational effectiveness and bottom line profits. Accordingly, there is a need to automate the management of files and/or business processes.

To accommodate this need, a software system and process (i.e., file control system) is provide herein that is intended to help users protect, control, and automate changes to a collection of files. The file control system may be implemented as a non-intrusive layer of software within the existing electronic file system of a business or organization. In this regard, the file control system may be incorporated into existing systems to allow for use of existing hardware and software. Such incorporation may allow for implementing the file control system with minimal training costs.

Generally, the file control system may be utilized, without limitation, for one or more of the following: automatically detecting, tracking and logging changes over the lifecycle of a file; automation of document creation, review, approval, notification, and distribution processes; controlling how people use the documents/files to eliminate non-approved or uncontrolled documents/files; maintaining a complete revision history of a document/file throughout its lifecycle; providing alternative document views (e.g., directories) based upon properties such as owner, roles, state, etc.; provide real time reports on the status of every phase of the document control process; automating the review validation and audit trail process; tracking files are that are accessed and by whom. Further, the file control system may provide simple and effective data protection that may include: automatic mirroring of all or targeted/controlled files; automatic snapshots of data at the time of a state/status change and/or continuous automatic backup of selected files.

Initially, a general overview of the file control system is provided followed by a system level discussion and a specific application.

General Overview

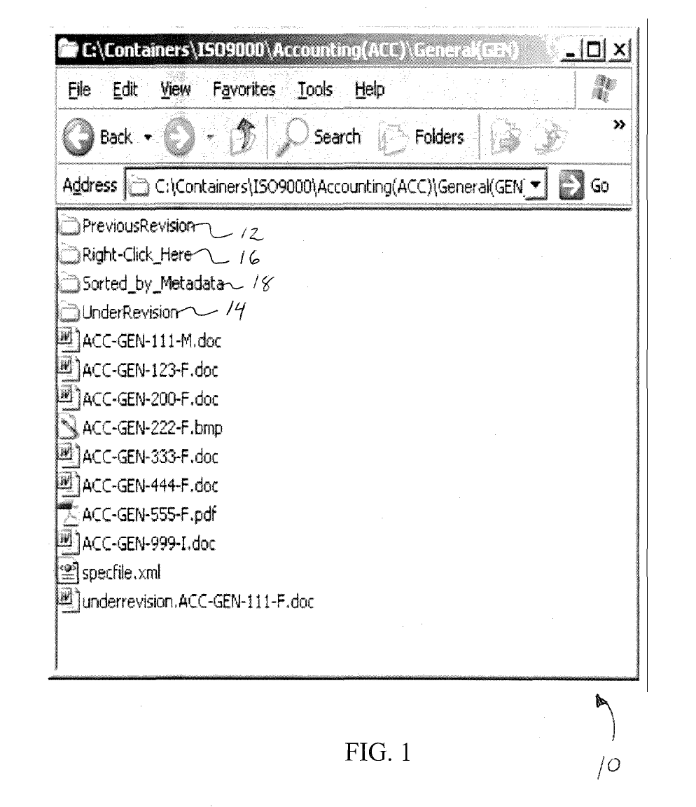

As noted above, the file control system comprises a software system and process that is intended to help users protect, control, and automate changes to a collection of files. Such a collection of files may be termed a container. FIG. 1, illustrates a container 10 mapped under a network drive. As will be appreciated, the file control system may be implemented for an entire computer network, or, implemented on limited portions of a network such as, for example, isolated drives or directories within a drive. As shown, the files may be stored in the existing file system of a computer and/or computer network and may be accessed like any other files using a file navigation tool such as, for example, Windows File Explore®. Once the file control system is implemented, double clicking on a file will open it as it did prior to implementing the file control system. However, additional protections and capabilities are added to the file system to support the controlled revision, approval, verification, tracking, and/or other controlled access processes. Generally, the container will display the most current version of any file and users may access these current (i.e., up-to-date files). In addition, the file control system will maintain a mirror copy of all of the current versions of each file. The container 10 may also include a folder of previous versions 12 of the files contained therein.

As presented, the file control system provides electronic file/document control and/or business process control. Generally, the file control system supplements an operating system, such as Windows, Linux, Unix, etc., with a few new commands. These commands can be accessed by right clicking either a directory or a file within a container. For instance, a drop down list of options may be presented when a user right clicks a file. In this regard, there is no separate graphical user interface for a user to learn. Stated otherwise, the file control system overlays existing operating systems and/or programs. When implemented into a file system, the file control system generates a mirror copy of the controlled filed (i.e., files and/or directories designated for controlled access). These mirror copies are only updated when approval for changes to the controlled files exists.

To obtain approval for changes to the mirror copy of a file, the file control system is operative to notify an authorizing user (i.e., an approver) when a controlled file is changed. In this regard, changes of a restricted/controlled file are brought to the attention of the approver via automated notification process (e.g., an e-mail notification). The notification may include information regarding what is requested of the approver and may include an automated link to the changed file. The approver may then review the changes to the file and approve/disapprove the change. Further, the file control system ensures that when a change is made to a controlled file, the mirror copy of the original unchanged file is still available, that the right people approve the change, and that everyone impacted by the change gets to see it and understands how that change may impact their job. Enforcing the change process is one of the capabilities of the file control system. If changes are not approved or if changes are made by an unauthorized user, the system may restore the edited controlled file with the mirror copy, which represents the last approved version of the file.

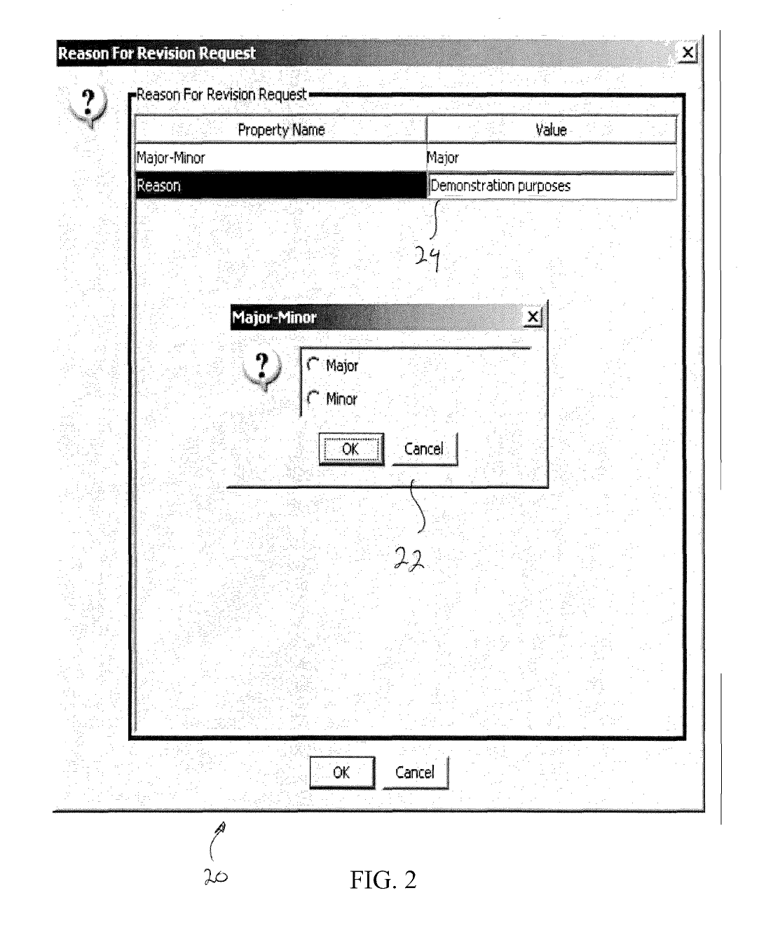

Changing a file in a container involves steps in addition just editing a file, such as in an uncontrolled directory. To change a file a user may, in one embodiment, right-click the file and select a ‘revise’ option (not shown) from a menu of options. A dialog box 20, See FIG. 2, may then be displayed asking for one or more pieces of information. In the present embodiment, there are two fields 22, 24 in the dialog box 20. The first field 2 is labeled Major-Minor. Clicking on the empty space to the right of the label causes a selection box to be displayed. Either Major or Minor, but not both, can be selected this way. This is to represent the severity of the change. A second field 24 can provide for entering the reason for the change. Additional fields may be provided that may include, without limitation, user ID, passwords, etc. Of course, the file control system may be operative to automatically record information associated with the user who is changing the file. In this case, if the user is determined to be authorized to make changes, they may access the controlled file and make their proposed changes.

Once the requested information is entered, the requested file will be placed in the UnderRevision directory 14 and the file in the main container 10 will be changed to underrevision.filename. See FIG. 2. This file is still the most recently approved document but, by its name, everyone can see that the file is in the process of being changed. The file will then be opened and the file can be edited. For example, if the file is a .doc file, Microsoft Word will be started to allow the user to edit the file. Importantly, the mirror copy of the file remains unedited during this process.

Once the changes/edits to the file are completed, a request for approval of those changes is made. This is done by going into the UnderRevision directory, right clicking on the file, and selecting a “request approval” option from a menu. The file control system will then change the state of the file, and notify the approver(s) responsible for the file via email that the file has been changed/edited and that the approver(s) need to look at the file.

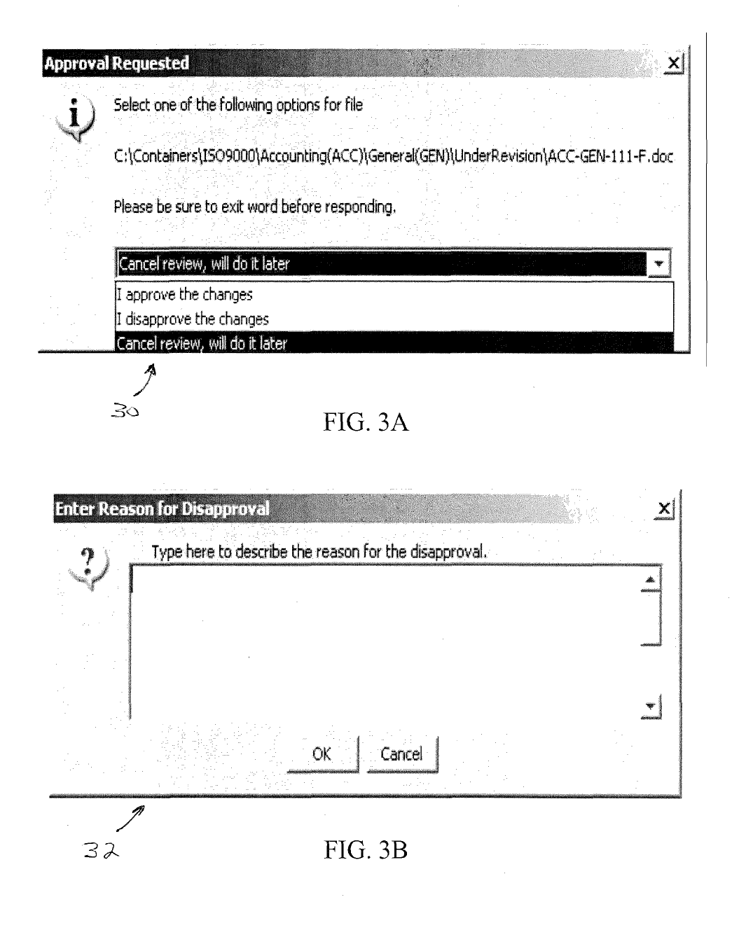

To approve a file, the file be may be opened, for instance by clicking on the actual file in the UnderRevision directory, a link in the email notice, or by accessing the file via one of the directories. A selection box 30 may be displayed which gives the approver(s) choices of what they want to do with the file and/or provides a dialog box 32 that allows the approver(s) the ability to comments on their actions. See FIGS. 3A and 3B.

When the last approver approves the change, the file control system will update the file in the main directory/container 10 and remove the underrevision. prefix from the file. See FIG. 1. It may also increment a revision value (e.g., a metadata tag) for the file and/or remove it from the UnderRevision directory 14. More importantly, the mirror copy of the previous version of the file (i.e., the original file) is replaced with the now authorized version. A notification (e.g., an email message) of the change may also be sent to all the users who interface to the file, for example non-approving users or users otherwise impacted by the change.

If one or more approver(s) disapprove of the changes, the file control system will send out a notice to each other approver (if any), regardless of other approvers having already approved the file, as well as to the changing user (i.e., the originator of the change). This notice may indicate that the file has been disapproved and include a statement for the reason(s) why. The state of the file will return to revising (i.e, as opposed to Approving) allowing for the user to modify further the file. The mirror copy of the original file remains unchanged. The originator can then request another approval.

In order to ensure the approvals/reviews occur in a timely manner, the file control system may be configured to send out reminder notices if an approver or other user has not responded within a set time period. Such a time period being set by, for example, an administrator. Accordingly, a report may be sent to the administrator each day identifying who is delinquent in reviewing files/documents.

All the responses from the users (e.g., approvers, requesters, reviewers) are logged in the file control system to verify everyone who needed to have either approved or reviewed the change has done so. Such a log may be accessible via a logs directory, which contains a log file for each file in the main container. Such a log may include a simple text file that describes all the activity of a file.

Sometimes it may be difficult for an approver to identify what has actually changed in a file for which an approval is requested. Accordingly, difference tracking programs may be utilized to compare the original file (i.e., the mirror copy) with the edited/underrevision file. For instance, for Microsoft Word® files, a difference function is supplied that allows comparison of the underrevision file with a previous versions of the file. In this regard, any changes between the two files may be highlighted.

Adding files to the controlled container(s) 10 may also be a controlled process. That is, in order to keep track of the files in the container 10 users cannot just drag and drop them into the container 10 at will. Generally, there are two ways to create a new file, creating a new file and importing an existing file. Creating a new file will build a new file from a template and import will add an existing file/document to the container 10. In both case, if the addition of the file is authorized, a mirror copy of the imported/created file is also generated. The two processes are similar.

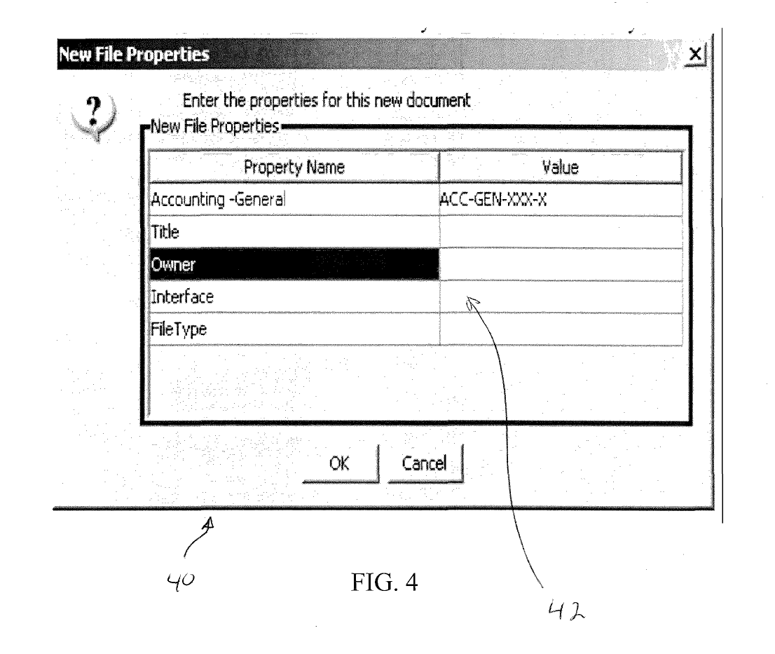

To create a new document from a template, a user may right-click on a directory (e.g., the Right-Click_Here directory 16 of FIG. 1) and select a create controlled document option. At this time, a dialog box 40 may be presented, and the user may enter requested data fields 42 regarding the new file/document. These requested fields 42 may make up some or all of the metadata originally associated with the file. See FIG. 4.

The first item in the data fields 42 list may vary with each container but will generally be the name of the file to be created. Depending upon how the container is configured, there may be a specific format the name must follow. Other potential metadata fields are more fully discussed herein. In addition, different templates that can be used in creating a file/document. Selecting one of the templates will cause the system to create the file based upon that template and file type.

Since the created file has not been approved, it is immediately put under revision and copied into the underrevision directory 14. See FIG. 1. The state of the file is then set to ‘Revising’ and approval of the created document can proceed as outlined above by requesting approval of one or more approvers.

A second method for adding a file is importing a file/document where an existing document and put it under control of the file control system. The process is similar to the creation of new documents. For instance, to import an existing file a user may right-click on the Right-Click_Here directory 16 (See FIG. 1) and select an import controlled document option. Metadata will need to be entered as with the creation of a file. Such metadata may allow for entering a initial revision value of the file. This is useful if it is coming from another system that might have a revision value assigned to the file. Such an imported file may require approval, or, may by-pass the approval process.

Once a new file has entered the file control system (e.g., via creation or importation), a user may request that everyone impacted by the new file be asked to read the file. This is useful to insure everyone who needs to look at the new file actually does.

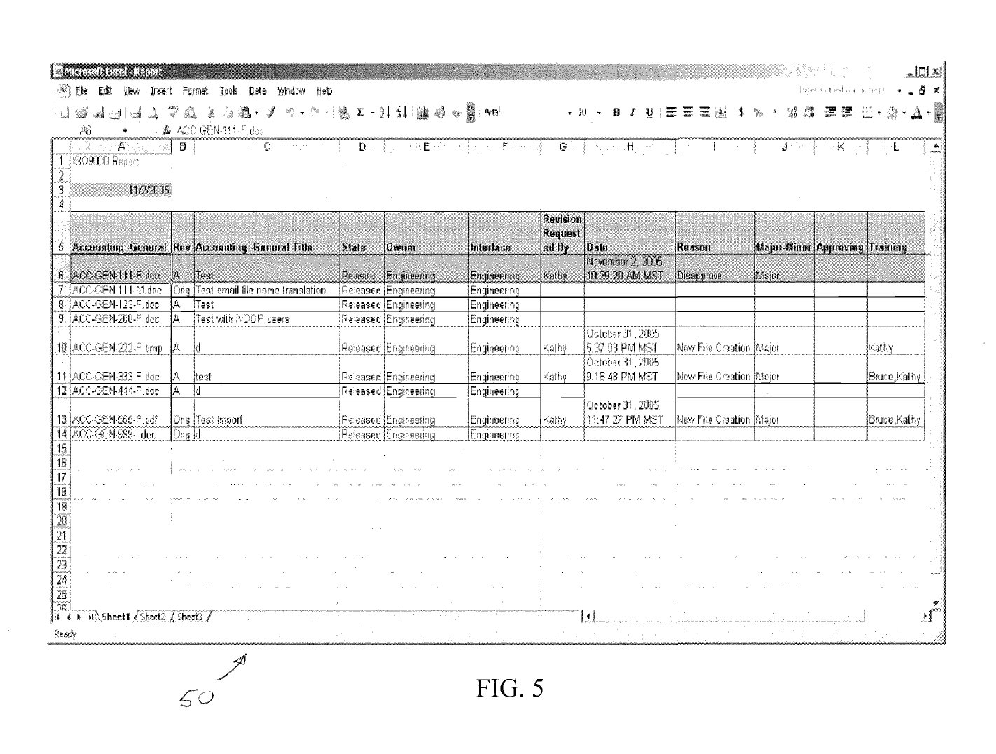

One feature of the file control system is the ability to add more information about the files by adding additional metadata (i.e., data about the data) in the data fields 42. To see the metadata for the files in a container, a user may right click one of the files or directories, e.g., Sorted_by_Metadata 18 in the main container 10. A list of commands will be displayed and select a user may select a report function. A spreadsheet 50 may be presented showing all the information about all the different files. See FIG. 5. Each column may represent a different type of metadata. Such data may include, for example:

| Metadata Name | Definition |
|---|---|
| Accounting-General | Main metadata value of the file. This |
| | translates into the filename and is unique |
| | for each container. For example, a |
| | Forms container may have this field be the |
| | “Form Number” |
| Rev | The revision of the file. The first value is |
| | “Orig” and incremented through the |
| | alpabet skipping “I”, “L”, “O”, and |
| | “Q” because they look too much like |
| | numbers. After Z, it shifts to a 2 letter |
| | revision “AA”, “AB”, etc. |
| Title | This is the title of the document, which |
| | may be useful to identify more |
| | than just its filename. |
| State | In this embodiment three states supported. |
| | Released, Revising, and Approving. |
| Owner | This is the department that owns the |
| | document. The document can generally be |
| | owned by only one department |
| Interface | These are the departments that interface |
| | with that document. For example, a |
| | document might be owned by |
| | Manufacturing but interface to Quality. |
| Revision Requested By | When a change is requested, this field |
| | identifies the actual person who requested |
| | the change. |
| Date | This is the date of the last state change of |
| | the document. It is cleared for files that are |
| | Released. |
| Reason | When a file is being modified, this is the |
| | reason for the change. This can be anything |
| | the user would like to enter. |
| Major-Minor | Identifies the severity of the change. |
| Approving | These are the login IDs of the users that |
| | have yet to approve the document. When a |
| | user approves it, their logon ID is removed |
| | from the list. |
| Training/Reviewing | These are the login IDs of the users that |
| | have yet to review the document. When a |
| | user reviews the file, their name is removed |
| | from the list. |

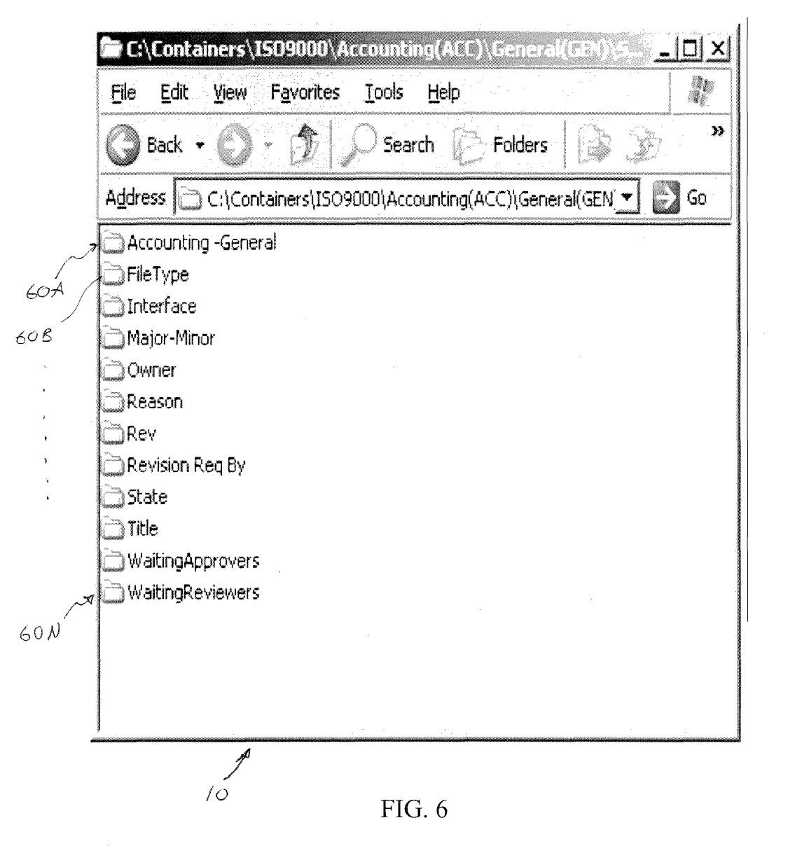

The files in the container 10 may be sorted into metadata directories 60A-N. See FIG. 6. As shown, in this directory, the files of the container 10 are sorted into other directories 60A-N that correspond to the different types of metadata presented in the spreadsheet. See FIG. 5. These are referred to as pivot directories. Such pivot directories may allow for sorting files in a more useful manner. For example, changes made by a single user to multiple documents may be grouped into a common directory (Revision Requested By). Alternatively, the files may be sorted by state to identify which files are, for example, awaiting approval. Stated otherwise, sorting files by metadata attributes may allow finding files or sets of files that are sorted in ways other than by the name of the file.

The pivot directories may be automatically maintained by the system as the various values change. The user can configure the system to create pivot directories for any the metadata items. For example, a “Customer” metadata field (not shown) could be used to create pivot directories so the user may sort files by customer. Then the user would only need to look in the Customer directory under the name of the customer to see all the files associated with that customer. The use of pivot directories provides a very quick and easy way to view the files associated with particular metadata.

In its simplest form, the file control system generates a mirror copy of all controlled or “original” files. The system then applies/controls the access to the original files. While users may access and change the original files, the system will revert to the mirror copy of the file if the user does not have the authority (e.g., as determined from log in information) to make the changes. That is, after the unauthorized user alters (e.g., edits, deletes, etc.) a file, the system will, upon the file being closed, replace the unauthorized edited file with the last authorized version of the file from the mirror copy. Alternatively, when a user with authority to change a file edits a file and requests approval, the mirror copy will be updated upon approval of changes to the file. Such controlled access to and replacement of files allows for controlling numerous business processes.

System Level Discussion

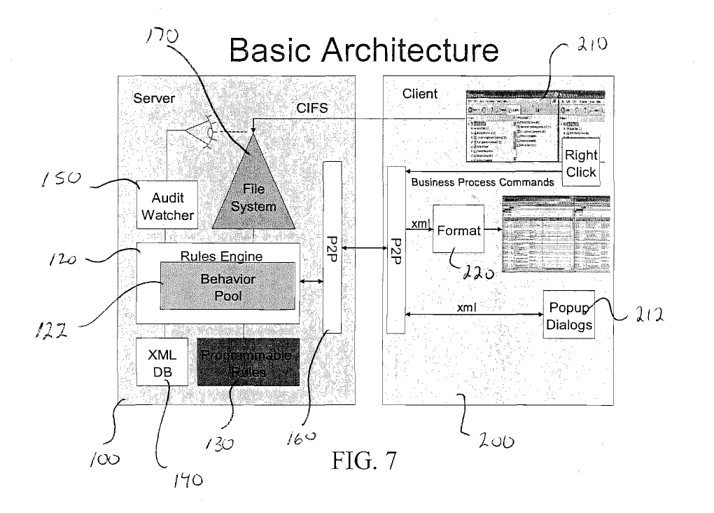

The file control system architecture is a client-server model where the business processes are executed on the server 100 interacting with one or more clients 200, which are interacting with one or more users. FIG. 7 outlines the general components of the system, which may be implemented with any appropriate file system 170 or portion of a file system.

As shown, the server 100 includes a rules engine 110 that drives the file control system. The rules engine 110 responds to events and executes the event sequences as defined by the programmable rules 120, which may be entered by, for example, a system administrator and may be tailored for an individual business process. Generally the rules may be kept in a simple text file and loaded during initialization. Changes to this text file can change the personality of the system or can be replaced to implement a completely different business process.

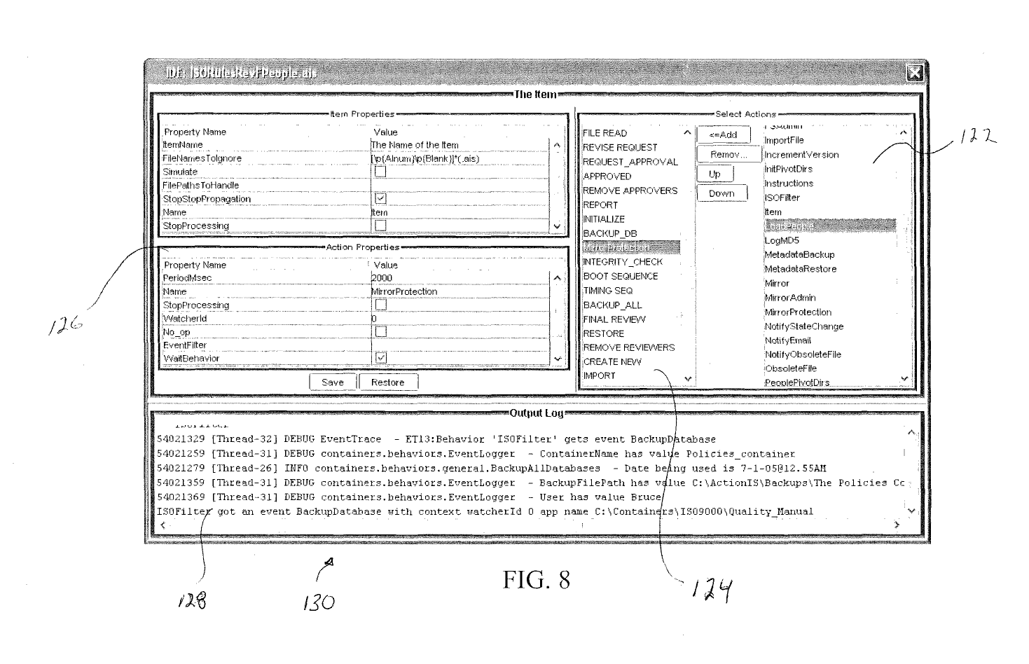

FIG. 8 illustrates an example of the programming interface 130 for the rules engine 120. The column on the far right is the behavior pool 122. The column just left of that outlines the event sequences 124. Additional areas are for configuring specific events 126 and an output log 128.

A unique aspect of the rules engine 120 is that it is hierarchical. In other words, an event sequence can trigger another event sequence as needed. Event sequences are triggered by predetermined commands or events. When such a command or event occurs, the system will automatically execute a series of steps that generally include permission checking, protections (such as starting a transaction), and action steps, which perform a function to or for the data. The sequence of these steps is referred to as an event sequence. These steps can be almost anything from displaying a set of instructions to the user, to modifying some metadata value. The capabilities here are limited only by the creativity of the programmer.

The behavior pool 122 of the rules engine 110 is a collection of possible behaviors that can be used by the rules engine 120 to create an event sequence. These range from the simple to the complex as needed by a particular business process. While every business process is a little different, a significant number of these behaviors are common to different practices and can be leveraged to implement new processes. That is, the behavior pool 122 implements a general set of features and capabilities that are useful for the implementation and/or automation of a business process for which the file control system is implemented to control. Further, the system allows for combining different features and functionality into an implementation for controlling a specific business process. That is, the system may be tailored to particular needs.

As utilized herein, the definition of a business process is the transition of files through states. For example, such states may include, without limitation, when a file is created, revised, approved, released, published, archived, made obsolete, etc. Each business process has the following attributes in the file control system:
1. Metadata about a file or set of files. Metadata is just data about the data. For example, a particular file that is a quote might have as one of its metadata items a customer name.
2. Directory structure. A directory structure is the key to the organization of the information. This would include directories such as PreviousVersion, which would contain the older versions of a file. This also would include the file naming conventions as required.
3. The different data states. These are the different states or conditions the files can transition through. These would be things such as “revising”, “approving”, “released”, etc.
4. Event Sequences for the transitions. Whenever a file transitions from one state to another, there are a set of checks and operations that are to be done when that occurs. An event sequence is the sequential set of steps that are to be followed when a transition occurs.
5. Mirror copy of all controlled files. Whenever a file transitions from one state to another, and that transition is authorized, the mirror copy is updated. If the transition is not authorized, the mirror copy may restore an edited/altered file to the last authorized version of the file.

Metadata is any additional data about a file or set of files that are either required or useful for the execution of the business process. These are configurable depending upon the needs of the specific business process. These are kept in a separate, internal database and can be calculated, retrieved, prompted for, or assigned as required. Note that this is separate from any type of attributes or properties of a file. A report function returns the values of each of the items for each file.

A directory structure is the backbone of the organization of files. The file control system can ensure the directory structure is maintained, that any uncontrolled files or directories are not created polluting the name space of the controlled files, can set the Access Control Lists (ACLs) for the files and directories automatically, and can maintain certain administration directories, such as a log directory as required by the business process. The file control system can also monitor the usage of the files. The system, for example, can tell when a particular file has been read by a specific user and can perform some additional function once that condition is detected.

The key to controlling a business process is the monitoring of the transition of a file or files from one state to another. The file control system will keep track of these states of each file throughout its entire lifecycle right from the moment of its creation to the possible deletion of the file. Being able to control the state of files and/or perform operations at the time of a state change is a key aspect of any business process.

As noted above, event sequences are where functions are performed. When a command or event occurs, the system will automatically execute a series of steps that generally include permission checking, protections (such as starting a transaction), and action steps, which do something to or for the data. These steps can be tailored for a particular business process. As noted above, the behavior pool 122 of the rules engine 110 is a collection of possible behaviors that can be used by the rules engine 120 to create an event sequence.

The server 100 also includes an XML database 140 that is used to store the metadata of containers controlled by the file control system. While other databases may be utilized to store this metadata, and are within the scope of the present invention, the XML database 140 provides excellent flexibility to add or modify entries as needed. One unique aspect of the file control system is that an XML file, which represents the current metadata for all the files, is copied out to the file system 170 allowing for very simple external processing. Also, this means the metadata is available even if the file control system is shut down or even uninstalled.

The file control system monitors what is happening to the files under its control through the audit watcher 150. That is, it will monitor the activities of the files and can generate events for the rules engine 110 to process. The name of the user, the system/client they are accessing it from, etc. are all available to the rules engine 110. This information can be used in many ways from simply logging who is accessing the files to implementing one or more event sequences upon identifying such information.

The last major section of the file control system architecture is the communication to the client 200. In the present embodiment, the file control system uses peer-to-peer technology 160 so the communication can occur with a local computer or, if configured, with a computer anywhere on the internet.

The client 200 and associated software provides the needed user interface functions and communication to the server 100. Since the file control system is built to overlay the file system 170, the main user interface 210 is though a file system viewer such as, for example, Windows Explorer®. The user only needs to right-click on a file or directory of the file system 170 as displayed by the interface 210 to see a list of functions that can be performed on the file. For example, to request that a file be changed, a “revise” right-click option may be selected. In this regard, a user does not need to run a specialized or otherwise complex GUI to operate the file control system. If a user does not access a file through the file control system (e.g., they open by left-clicking), the system may revert the file to the mirror copy when the user closes the file. Of note, the file system 170 may be utilized to store the mirror copies of the controlled files/directories. Alternatively, the mirror copies of the controlled files/directories may be a separate file system (e.g., server), which may be remotely located.

Certain steps in the controlled execution of a process require either notification or feedback from the user. This is done with simple dialog boxes 212 that are displayed to the user via the user interface 210. These dialogs walk the user through the steps as needed ensuring the steps are followed and cannot proceed if there is a problem, such as some missing metadata.

An authorized user is also able to view the status of the entire collection of files being controlled in the file system 170 using a provided report function. When implemented, the server 140 will provide the current metadata for all the files in the XML database 140 to the server 200. The XML data is passed through a formatter 220 and displayed on the user interface 210 for display. The formatter 210 can be any tool or program that can display the data but one of the more powerful methods is to populate a spreadsheet. This allows the user to do very sophisticated searching, sorting, formatting, charting, etc. on the data with a tool already familiar to the user. Again there is no specialized or otherwise complicated GUI for the user to learn. The file control system maintains the way the users already use files and supports the tools already in place. Accordingly, the amount of user training required is significantly reduced.

In this regard, the file control system is an overlay system interface. The overlay interface is transparent to the files and applications of the server 100. To access the overlay system in the present embodiment, the user right clicks their mouse to access the file control system options for any file in a container, directory etc. As noted above, the file a user works on is placed in an underrevision directory, and the system maintains a mirror copy of the file. In this regard, users access files on the server, and back-up/mirror copies are maintained. Therefore, when users access the system it appears to the users that the files they are editing are actually being changed. In this regard, each of the clients is allowed to write information to the files on the system. This is particularly useful since the client is enabled to make virtually whatever modifications to the files as the client may desire; however, the mirror files are not modified until the changes are authorized by an approver, thus, the system allows for readily restoring files after authorized changes. Further, such restoration may be automated.

A key feature of the file control system is that as it overlays the existing file system to add to its functionality, all the files stored in the directory structure are still accessible should the file control system shut down for any reason. Users can still access files (although the controls and automation will not be available) keeping a company/organization operational during a shutdown or maintenance period.

As an example of the operation of the overlay, if a client desires to remove a file contained in the server, he would execute a command based on his particular operating system to direct to the server to erase the particular file. The change would be recorded by the system. It would thereafter appear to the client as if the file had been erased. However, the mirror copy of the file in the server is unaffected (unless the erasure/deletion is approved). The mirror copy may be restored once the unauthorized user logs off. This may prevent unauthorized file removal by, for example, a disgruntled employee.

While in one embodiment the file control system is applied to the Microsoft Windows platform/operating system, the file control system may be written for different operating systems or be written for use across different operating systems. For instance, the server 100 may support a first operating system, and the client 200 may support a second operating system. In one embodiment the file control system is written in Java for portability. The right-click commands are all written in java and are therefore portable to other systems. Any system that has a common file system access such as, for example, common internet file system (CIFS) access to a windows server can be supported. (Note that a number of systems including most Unix and Linux systems support CIFS). All the dialogs are in the present embodiment written in Swing (a graphics package for Java) and are supported on many different platforms. Accordingly, the report formatter just has to process XML and format it in a standardized manner. In this regard, the client software may be written for portability and may support a vast number of different clients should the need arise.

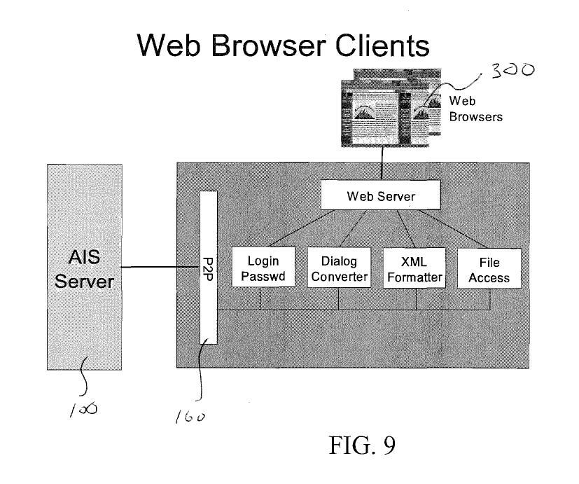

While the client software may be ported to many systems, it may not be possible or desirable to have a file system interface to the controlled files. A web browser interface used as an intranet may in some applications be more appropriate. To provide web access to the system to support all the client capabilities, a web server may be configured to interact with the server 100 to support the required functions. In this arrangement, commands are implemented as buttons on a web page 300 and the dialogs are handled as a form by the user browser. See FIG. 9. Accordingly the xml formatting can be done using any one of the available client side scripting languages. Access to the files would be controlled via a login/view/download process. The basic architecture of the web-based system is illustrated in FIG. 9. This architecture may include a PLP interface 160, a web server 310 and associated functionality.

Situations may arise where someone external to the organization may need access to the information related to a business process. A customer may want to know how many of their parts failed inspections or a customer may want access to the current defect list. While the need for access is justified, it is often difficult to manage the security aspects of letting someone from the outside have access to you're a controlled system. Giving them remote login access risks exposure to private information or problems not intended for their view.

The file control system provides a solution to this conflict. The files to be accessed remotely may be automatically copied to a private location on a web server accessible only to that particular external user. The external user may then access that web server and view all the data. Since it is a copy, any changes that might occur on the web server could be quickly restored. At no time would the external user have access to the normal system.

For example, if a vendor wanted to see all the inspection forms for his products, the name of the vendor could be setup as a metadata item and a pivot directory created for each vendor. That particular vendor would have a pivot directory that would hold the inspection forms for the vendor. That directory/files could then be copied to the web server (under a private location) so that at anytime, the vendor could view all the relevant forms. The file control system would automatically update the files (i.e., from mirror copies maintained by the server) whenever any of the files were changed or new ones created. This eliminates the problem of trying to maintain two copies of data, one on an internal system, and the other on an external web server.

Exemplary Application

One business process that may be controlled by the file control system is the tracking of ISO9000 documents. As will be appreciated, ISO 9000 is a family of standards for quality management systems maintained by ISO, the International Organization for Standardization and is administered by accreditation and certification bodies. For instance, for a manufacturer, some of the requirements in ISO 9001 (which is one of the standards in the ISO 9000 family) would include: a set of procedures that cover all key processes in the business; monitoring manufacturing processes to ensure they are producing quality product; keeping proper records; checking outgoing product for defects, with appropriate corrective action where necessary; and regularly reviewing individual processes and the quality system itself for effectiveness. However, it will be appreciated that ISO 9000 may be implemented in very diverse business settings.

Many companies have found conforming to ISO 9000 is difficult as the compliance process is costly and time-consuming and generally considerable administration is needed to implement it. Two types of auditing are generally required to become registered to the standard: auditing by an external certification body (external audit) and audits by internal staff trained for this process (internal audits). The aim is a continual process of review and assessment, to verify that the system is working as it's supposed to, find out where it can improve, and to correct or prevent problems identified. Accordingly, the tracking an updating of documents (e.g., to implement changes in processes etc.) is a key to ISO 9000. The file control system streamlines the updating and review of documents in the ISO process.

The key requirements here are the ability to have only the latest versions of documents available to users, prevent any unauthorized modifications to the files, and to force an approval for any change. After a change has been approved, all the users that are impacted by that change need to be made aware of the change, and to acknowledge they understand how that change impacts their job. Traditionally, this has been done with paper documents. A change request would be sent to an administrator who would then allow that change. Once complete, a clerk would send a copy to everyone who needed to approve the change and to get their signature. Once all the signatures were collected for approvals, a copy would be sent to each person who had to interface with the document (which could be a sizeable number), and their signatures would be obtained, identifying they understood the changes. The present file control system allows for streamlining and substantially automating this process.

The file control system allows such documents to remain in a file system in their native format (generally Microsoft Word) but adds the necessary controls. The master directory (e.g., container) only holds the most recent version of all the files so every user knows these are the ones to reference. No uncontrolled changes can be made to the files, which are protected by access control lists (ACLs). Should someone bypass these and actually manage to modify or delete one of the files, the system will automatically restore the file from its internal mirror.

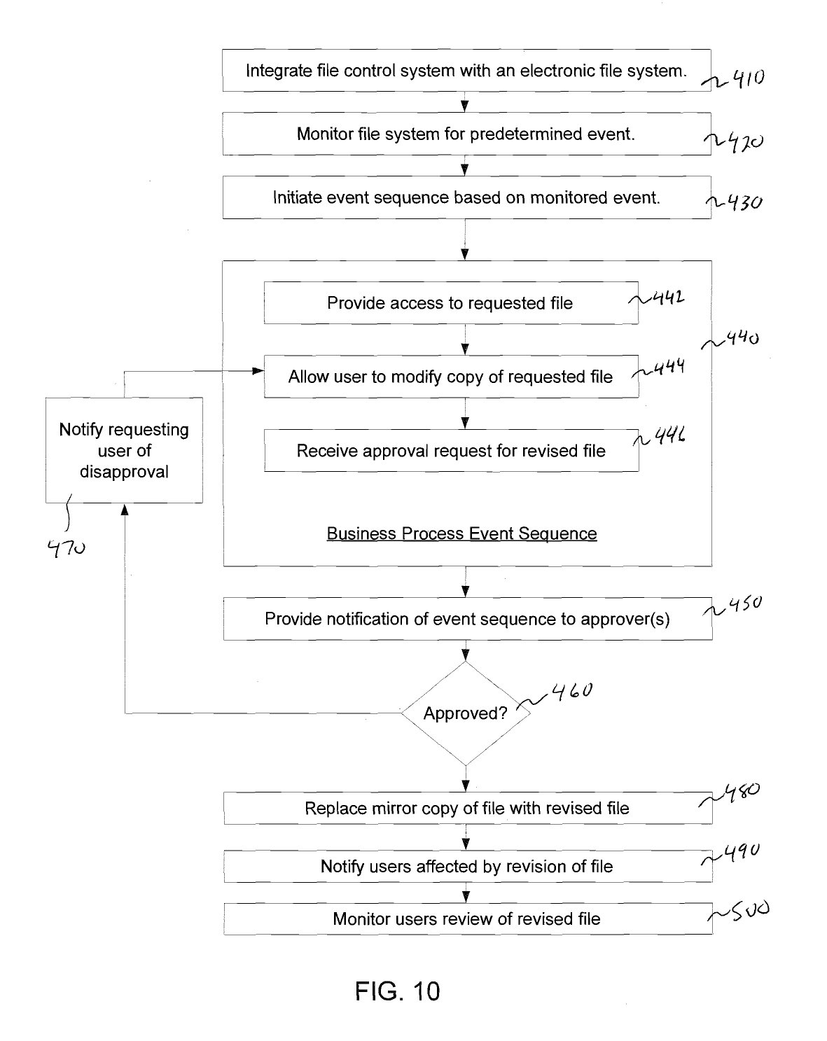

A process flow diagram (400) for an event sequence that may be utilized for ISO9000 compliance as well as other business processes is illustrated in FIG. 10. After the file control system is integrated (410) with a file system and mirror copies of the controlled files are created, a user may right-click or otherwise controllably access a desired/requested file and select revise. In this regard, the file control system monitors (420) the file system for events (e.g., inputs) associated with data/files the file. This may initiate (430) an event sequence (440). It will be appreciated that any event sequence may be initiated based on the monitored event. For purposes of discussion and not by way of limitation, the event sequence discussed herein is directed to a process that may be utilized to control the updating of documents in a file system. However, it will be appreciated that the general discussion is applicable to other data types and other business processes. In any case, most event sequences will, for example, check for permissions, prompt for the reason for changes, etc. In the present event sequence (440), the file control system will provide access (442) to the requesting user if that user has proper credentials. A requesting user may then edit, revise or otherwise change (444) the requested file. Once the file is revised, the user requests approval for the change (446). The system will then send a notification message (e.g., email) (450) to all the approvers notifying them of the request to change a file in the system. Those users may then open and review the revised file and/or compare the revised file with the original/mirror copy of the file maintained by the system. Once the revised file is opened, the system will detect the condition and ask the user if they approve the changes or not (460). If disapproved, a message may be sent (470) to the user who originated the changes indicating disapproval and/or reasons for disapproval. The user may then further amend the file. Once all the approvers have agreed the change is correct, the mirror copy of the file may be replaced (480) with the revised file (the original file may be archived) all the users that interface to the document (e.g., reviewers) may be notified (490) of the revision/changes to the file and/or requested to review the revised file. Such reviewers may open the file and may be prompted as to their understanding of the change. The system may monitor (500) the access to the revised file. For instance, various timers may be monitored so that should someone forget to respond to a request, the system will automatically remind that person via email that they are to do something. All the activity of every file and every user is monitored and tracked to support later auditing.

One of the major challenges with a system such as this is the routing of documents. When a request for approval is made, the system needs to determine who should be notified of the change and ask for their approval. The file control system in one embodiment accomplishes this using a simple spreadsheet outlining the people involved and their roles. The table below gives a sample of the how the spreadsheet is configured:

| | Login | Email | Job | | |
|---|---|---|---|---|---|
| Name | Name | Address | Description | Department | Role |
| John | jdoe | jdoe@com | Manager | Engineering | Approver |
| Doe | | | | QA | |
| Bob | bsmith | bsmith@com | VP | Marketing | Approver |
| Smith | | | | QA | |

The first line in the file gives the specifications for John Doe. Note that he is a manager for the Engineering department and is an approver for all file changes that impact that department. The second line shows that John is also involved in the QA department. The Role column is blank indicating that he is a reviewer of any changes that impact that department as well. (The word “Reviewer” can also be placed there but a blank is just a matter of convenience).

For many companies, a simple spreadsheet is more than adequate for keeping track of who is in what department. Larger organizations may want to utilize more detailed directories to keep track of this information. Though two roles have been discussed, those of reviewer and approver, it will be appreciated that additional roles are possible and within the scope of the present invention.

Design Patterns

As will be appreciated, many business processes in addition to the above-noted ISO 9000 process may be implemented using the file control system. Such business processes may share a relatively small number of design patterns. Most real-world business processed/systems need either some tailoring of an existing process or the combination of design patterns to satisfy the transition of data between different states in accordance with the specific needs of the business process. A few of these design patterns are outlined here. These design patterns include lifecycle, ownership, creation, recurring and fulfillment. Other design patterns are possible as well.

A design pattern is implemented with a collection of specific metadata and event sequences that will implement the transitions of data among the required states. In practice, it is a set of behaviors in the behavior pool and a rule file designating the required event sequences.

The lifecycle design pattern tracks the changes to a file throughout its lifecycle from creation to obsolescence. The major emphasis of the pattern is in keeping control over changes to a document. The lifecycle design pattern is the one similar to the one used in the ISO9000 example above.

The ownership design pattern is concerned with the ownership of something. The key part is that ownership is assigned and transferred as related to some item such as an issue, problem, request, plan etc. The item will go through a series of states such as submitted, assigned, reviewed, complete, closed, etc.

The creation design pattern focuses primarily on the creation of the file itself. Once it is created, changes are tracked using the lifecycle pattern but the major thrust of the work is during the creation process. The creation process adds an additional state to allow the tracking of the creation process itself.

The recurring design pattern is concerned about scheduling recurring tasks in the future and tracking the execution of these tasks. Reminders prior to an event can be sent and a summary of when things are to be done can be generated. This design pattern is used for things such as tracking permits, leases, equipment calibration, contracts, agreements, etc. Each file could be viewed as a lease with the metadata defining when the lease expires. A notice can be sent out prior to the lease expiring to allow for the cancellation, renewal, renegotiation, etc. of the lease.

The fulfillment design pattern relates to a collection of files that all need to exist before something can happen. For example, a proposal might need to have a dozen separate files, each one being required before the proposal can be submitted for approval. The fulfillment design pattern can have a set of required and optional files, which itself could be different for each collection. Further applications include, for example, blueprints for products having multiple interacting parts.

The ability to apply pre-built design patterns to a particular business problem/process is the key to the power of these patterns. A pattern can be created and then applied to a particular problem by specifying the right metadata and directory structure and then tailoring the event sequences if needed. The full capabilities of the system can quickly be deployed on the problem. Should a business process that does not exactly fit the available design patterns be discovered, one or more of the existing design patterns can be used as the basis for this new pattern. This new design pattern is now available for use with future business processes. The system quickly becomes able to tackle a very large number of business processes without significant new development. Also, additional capability put into the system is now available for all the design patterns to incorporate.

Storage Management

Not all storage is created equal. Some storage devices, such as RAID systems are very fast and reliable, handling drive and controller failures without skipping a beat. These are, however, very complex and expensive. Like storage, not all data is created equal. For example, the most recent versions of files, or the most active forms are very important but previous revisions are less so. Ideally, the different types of data would be stored on an appropriate storage medium based upon their business importance.

The key to implementing this type of organization known in the industry generically as Information Lifecycle Management (ILM) is to understand the business importance of the data. Only then can a system select the most appropriate storage method for the data. The file control system is uniquely suited to make such a decision. For example, previous versions of a file may be moved to inexpensive storage (e.g., removable tape drives) or in a compressed directory. In contrast, current versions of files (master files) may be stored or backed up on more readily accessible storage. That is, as the file control system differentiates between most recent data files and previous versions of those files, the files can be separately stored. This may be done safely without risking the performance of the master files.

Another aspect of the file control system is that it can be programmed to delete old data as appropriate, thus avoiding the inevitable “out of space” problem of unending data growth. Should the situation warrant it, the AIS system can track only a running window of data deleting the oldest as new data is created.

The file control system is also able to address the archiving needs of the data based upon the actual business process driving the data. The system can now tell if the file is the current revision or a previous revision and handle the previous revisions differently.

1-10. (canceled)

11. A method for controlling electronic files, comprising:
integrating an electronic file control software system with a file navigation tool of an electronic file system, wherein the software system controls access to controlled files within the electronic file system via the file navigation tool;
generating mirror copies of said controlled files, wherein said mirror copies represent the latest authorized version of said controlled files;
identifying access to and an alteration of a controlled file in the electronic file system, wherein the altered controlled file defines a revised version of the controlled file;
sending a notification to at least one approving entity, wherein the notification indicates that the revised version of the controlled file has been generated.

12. The method of claim 11, further comprising:
receiving approval from the at least one approving entity; and
replacing the mirror copy of the controlled file in the electronic file system with the revised version of the controlled file to generate a new version of the mirror copy.

13. The method of claim 12, further comprising:
achieving the mirror copy of the file in conjunction with replacing the mirror copy of the controlled file with the revised version of the controlled file.

14. The method of claim 12, further comprising:
sending a notification to a predetermined set of users impacted by revised version of the controlled file.

15. The method of claim 14, further comprising:
logging access of the users to identify which users have reviewed the revised version of the controlled file.

16. The method of claim 15, further comprising:
after a predetermined time, sending a reminder notification to users who have not accessed the revised version of the controlled file.

17. The method of claim 11, further comprising:
receiving disapproval from the at least one approving entity; and
replacing the revised version of the controlled file with the mirror copy of the controlled file.

18. The method of claim 11, wherein sending the notification further comprises providing direct access to the revised file.

19. The method of claim 11, further comprising:
receiving an access request for a user accessing the controlled file, wherein the access request is received via the file navigation tool, wherein the software implements an event sequence upon receiving the access request.

20. The method of claim 19, wherein the event sequence performs a predetermined set of operations upon a controlled file transitioning between file states.

21. The method of claim 11, wherein integrating the software system comprises providing an overlay interface on the file navigation tool.

22. The method of claim 21, wherein the overlay interface is substantially transparent such that the file navigation tool is visible in substantially the same form as prior to the integration of the software.

23. The method of claim 11, wherein the software is integrated with Microsoft Windows Explorer.

24. The method of claim 11, wherein access is provided in a client/server architecture.

25. The method of claim 24, wherein access is provided in a peer-to-peer network structure.

26. A software system that provides document control, wherein the software system is operable within a Microsoft Windows based operating system environment, including:
an interface module that communicates information pertaining to the document control via Microsoft Windows Explorer;
a document control module that determines when a change is made to a document, wherein the document control module generates the notification message indicative of the change; and
a mirror directory, wherein the document control module copies documents into the mirror directory, wherein changes to documents are not initially made to their mirror copies prior to authorization.

27. The software system of claim 26, further comprising notification means for electronically notifying at least a first entity when a change is made to a document.

28. The software system of claim 26, further comprising:
a peer to peer module for interfacing the software system with the internet.

29. A method for controlling electronic files, comprising:
integrating an electronic file control (EFC) software system with a file navigation tool of an electronic file system, wherein the EFC software system controls access to files within the electronic file system via the file navigation tool;
generating a mirror copy of the files within the electronic file system, wherein the mirror copies are authorized version of the files;
monitoring the electronic file system via the navigation tool to identify a predetermined event associated with a file;
initiating an event sequence upon identification of the predetermined event, wherein at least a first predetermined operation is performed to the file.

30. The method of claim 29, wherein the predetermined event is a state change of the file, wherein the file transitions from a first state to a second state.

31. The method of claim 30, wherein the state change includes an access request from a requesting user to access the file, wherein the event sequence includes:
identifying a change to one of the files in the electronic file system; and
sending a notification to at least one approving entity, wherein the notification indicates that the file has been revised.

32. The method of claim 31, further comprising:
receiving approval from the at least one approving entity; and
replacing the mirror copy of the file in the electronic file system with the revised file to generate a new authorized version of the file.
